(19) United States
(12) Patent Application Publication
(10) Pub. No.: US 2023/0057981 A1
(43) Pub. Date: Feb. 23, 2023

(54) SMART HOT PLATES

(71) Applicant: REBEL FOODS PRIVATE LIMITED, Pune (IN)

(72) Inventors: Uday MAHAJAN, Pune (IN); Ashish Deelip GHATGE, Aurangabad (IN); Neelaabh Rabindra PAL, Bhagalpur (IN); Soumyadeep BARMAN, Kolkata (IN); Vijay Premshankar PANDEY, Mumbai (IN); Sudeshna TRILOK, Bangalore (IN); Dalyn Peter FERNANDES, Mumbai (IN); Jayakumar B, Tirupur (IN); Kamendra Singh CHAHAR, Agra (IN); Pankaj YADAV, Gurgaon (IN); Prasenjit DAWN, Hooghly (IN); Salil P SAPRE, Mumbai (IN); Sachin Mohan KORDE, Dombivali (IN); Vamsi Krishna MUDUMBA, Mumbai (IN); Vishal SINGH, Mumbai (IN)

(73) Assignee: REBEL FOODS PRIVATE LIMITED, Pune (IN)

(21) Appl. No.: 17/797,834

(22) PCT Filed: Apr. 12, 2021
(86) PCT No.: PCT/IB2021/053011

§ 371 Date: Aug. 5, 2022

(30) Foreign Application Priority Data
Apr. 13, 2020 (IN) 202021010870

(51) Int. Cl. A47J 37/06; A47J 37/10

(52) U.S. Cl. CPC A47J 37/0611; A47J 37/106; A47J 37/108; A47J 2037/0617

(57) ABSTRACT

A system (1) of hot plates (2, 3) includes more than one hot plates (2, 3), a heating medium (4) which heats the hot plates (2, 3), and a cooking medium dispensing means (5). The hot plates (2, 3) have at least one of the plates as an upper plate (2) and at least one of another plate as a lower plate (3), wherein the upper plate (2) and the lower plate (3) are functionally coupled to press and heat a food item when the food item is placed between the plates (2, 3). The cooking medium dispensing unit/component/etc. (5) dispenses a predefined quantity of the cooking medium at least on an upper surface of the food item, or a lower surface of the food item.

### CROSS-REFERENCE TO RELATED APPLICATIONS

This application claims priority to IN Patent Application No. 202021010870 filed on Apr. 13, 2020, and this application claims priority to and is a 371 of international PCT Application No. PCT/I132021/053011 filed on Apr. 12, 2021, the entire contents of which are hereby incorporated by reference.

### FIELD OF INVENTION

The present invention relates to pan frying the food items. More specifically the invention relates to pan frying the food items from both side without flipping the food item.

### BACKGROUND OF INVENTION

Hot Plates are used to pan fry the food items, mostly flat breads, by applying heat and pressure onto the food item. While pan frying the food in a pressurized fashion, various process parameters are to be taken care of for a preferred cooking of a food item. These process parameters relate to amount of pressure to be applied on food item, amount of cooking medium, like oil or ghee to be used on food item, and temperature to be applied onto food item during the cooking of the food item. It is pertinent to be noted, in some of the cases, these process parameters are required to be changed multiple times during a cooking process of single dish too. Accordingly, pan frying of foods in a pressurized manner is a highly skilled job, and requires experienced Chefs to cook the desired dish, with a desired consistency, like more crispy, flaky, or soft texture of the food item. Also, it is to be noted that only one Chef can handle one equipment/machine at a time because his regular involvement is required to complete the cooking of a dish.

In today's time, when it is desired to have cost efficiency and high throughput in commercial kitchens, to be cost competitive, it is desired that such cooking process should be automated, as well as, deskilled, so that specialized Chef may not be required to carry out such cooking techniques.

In one prior art patent U.S. Pat. No. 8,820,221B2 titled “Compact appliance for making flat edibles”, discloses a compact apparatus for automatically making a plurality of flat edibles includes a storage and dispensing unit that makes it unnecessary for a user to pre-measure ingredients. The apparatus also includes a mixing and kneading unit for making dough of optimal consistency. The mixing and kneading unit may be configured to prepare dough. The dough may be prepared by mixing and kneading the ingredients dispensed by the dispensers. The dough prepared may be transferred onto a lower platen from a transfer base by a transfer sweeper. The dough may be flattened in a platen unit. An upper platen and the lower platen of the platen unit may be heated to a pre-programmed temperature for cooking the flat edible. The temperature may also be manually set by the user based on user's preference. The flat may be cooked (e.g., heated, roasted and/or puffed) by the platen unit.

Another prior art patent U.S. Pat. No. 9,848,607B2, titled “Machines and methods for making flatbreads” discloses a cooking mechanism and method of making a flat bread that does not require any flipping of the dough product and that which achieves an irregular temperature profile during the cooking process is described.

Another prior art exists U.S. Ser. No. 10/080,369B2, titled “Microcomputer-controlled mesh basket automatic lifting device of an electrothermal frying pan” discloses various examples related to making flatbreads such as, e.g., a compact machine for making flatbread in a residential kitchen-type environment or other countertop, tabletop, or space limited applications. In one example, a machine includes a hopper including a mixing chamber configured for bulk addition of raw materials for preparation of flatbread pieces; a mixing assembly configured to blend the raw materials into a flatbread dough mixture; a dough piecing assembly configured to generate a dough piece from an extruded portion of the flatbread dough mixture; a lower platen configured to transfer the pressed flatbread dough piece to a cooking zone on the dough contacting surface for cooking; and a flatbread ejection station configured to remove a cooked flatbread piece from the machine. A second cooking zone can be included to further cook the pressed flatbread dough piece prior to ejection from the machine.

Another prior art exists U.S. Ser. No. 10/334,984B2, titled “Apparatus and methods for making bread” discloses devices and methods for automating the process of making flatbread, such as roti. In some embodiments, an apparatus includes a housing, an ingredient metering assembly, a mixing bowl assembly, a mixing actuator assembly, a cooking assembly, and an electronic assembly. The housing defines an interior volume and has several access openings with corresponding lids and/or covers. The ingredient metering assembly includes a flour container assembly, a flour delivery system, a water reservoir, and an oil reservoir. The mixing bowl assembly includes two bowls and a measurement system. The mixing actuator assembly includes a mixing mount, a mixing motor, a mixing paddle assembly, and a lower motor. The cooking assembly includes two platens and an actuator assembly. The electronic assembly includes a power source, a control module, and a LCD input/output screen. All components are integrated within the housing such that the apparatus is a consumer grade countertop appliance.

Another prior art exists US20190246834A1, titled “Dual-purpose electric cooker” discloses a dual-purpose electric bread cooker having two baking plates, a lid, a base, thermostat control knobs, light indicators and legs. The base on the electric bread cooker having a cylindrical shaped baking pan for baking Himbasha (also known as Ambasha) bread and a top plate pivotally mounted on to the base plate, the top plate covers the bottom baking plate when baking Himbasha. A first embodiment shows the top plate can be opened about 180 degrees from the surface of the bottom plate to be used to bake Injera (Ethiopian flatbread). A second embodiment of flip-able lid can used when cooking space is small. The top and the bottom baking plates may be connected to heating source. One temperature control knob controls the temperature of the bottom baking plate and another thermostat knob controls the temperature of the top baking plate. The electric cooker has a handle to open and close the lid, the inside of the top lid is a baking plate. The cooker also has additional lid to be used to cover the top baking plate when baking Injera break. The electric cooker also has bread stamp set with different stamp shapes that can be used to make different shapes on the top surface of Himbasha bread.

The apparatus disclosed by the prior arts has limitation to pan fry food items in a pressurized manner. Further the apparatus disclosed by the prior arts has limitation to efficiently pan fry the large batches of food items regularly, as the prior arts misses out to provide an efficient mechanism to pan fry the food items in a pressurized manner automatically, where the heat is regulated, movement of the plates are regulated, management of the gap between the plates while the plates are pressing over the food item is regulated, dispensing of predefined quantity of oil is automated and various other process parameters are automated by automation components of the apparatus. Also, these devices may still require specialized Chefs to cook, as there are no mechanisms provided to enable a Novice to cook complex pan-fried dishes in pressurized manner. Hence, a lot is left to be desired by the prior arts, and they do not solve the problem of commercial kitchens who have to optimize costs, standardize processes in a widely competitive market.

### OBJECTIVE OF INVENTION

The objective of the invention is to provide a hot plate system which pan fries the food items without flipping the food items, and which do not require high skills to handle and to cook complex dishes consistently, and which further reduces cooking efforts of a user by automating pan-frying operations in pressurized manner.

### SUMMARY OF INVENTION

The objective of the invention is achieved by a system of hot plates according to claim 1.

The system of hot plates includes hot plates and a heating medium which heat the hot plates, and a cooking medium dispensing means. At least one of the plates is an upper plate and at least one of another plate is a lower plate, wherein the upper plate and the lower plate are functionally coupled to press and heat a food item when the food item is placed between the plates. The cooking medium dispensing means dispenses a predefined quantity of the cooking medium at least on an upper surface of the food item, or a lower surface of the food item, or both sides. This embodiment helps in dispensing of cooking medium like, oil, ghee, or butter, onto the food items in a predefined quantity, so that the process of dispensing a desired quantity of oil for a specific food item can be deskilled.

According to one embodiment of the system of the hot plates, wherein each of the plates are either categorized as the upper plate or the lower plate. The upper plates and the lower plates are functionally coupled together to press and heat a food item when the food item is placed between the plates. This embodiment provides for multiple food items to be cooked together at the same time. It is pertinent to be noted that there can be only one upper plate and multiple lower plates, or multiple lower plates and single upper plate. In embodiment of single lower plate, it helps in easy placement of the dishes by the chef, without thinking much about the position of the food item, and also cleaning of a single lower plate shall be more convenient than multiple lower plates, specially when excess cooking medium left out after cooking of the food items needs to be removed and collected. In embodiment of single upper plate, it shall be helpful for moving the upper plate, as single movement mechanism shall be required to handle one large upper plate.

According to another embodiment of the system of hot plates, wherein the cooking medium dispensing means is adapted to dispense the cooking medium onto the upper plate or the lower plate or combination thereof. This embodiment provides for another way to provide the oil between the plates and surface of the food item for pan-frying operation.

According to yet another embodiment of the system of hot plates, wherein the cooking medium dispensing means is adapted to firstly dispense the cooking medium onto the lower plate and thereafter onto the upper surface of the food item. This embodiment provided for yet another convenient way to provide the oil between the plates and surface of the food item for pan-frying operation.

According to one embodiment of the system of hot plates, wherein the cooking medium dispensing means is placed on a side wall of the system which gets exposed to the upper plate and the lower plate, when at least one of a corresponding edge of the plates moves away from each other, and the cooking medium dispensing means dispenses the cooking medium when it gets exposed to the upper plate and the lower plate. This mechanism provides for a convenient way to place the cooking medium dispenser which can dispense oil conveniently on lower plate, and on to an upper surface of the food item at appropriate steps of cooking operations, and without spilling or wasting the oil.

According to another embodiment of the system of hot plates, the system includes a dispensing controller adapted to control dispensing of the cooking medium onto the food item. This helps in controlling of dispensing the oil, so that the oil is dispensed only in predefined quantity

According to yet another embodiment of the system of hot plates, wherein the upper plate and the lower plate are physically coupled to each other around a hinge, so that the upper plate and the lower plate moves with respect to each other around the hinge for pressing and heating the food item, exposing the cooking medium to the upper plate and the lower plate, or giving access to the food item. Hinging the plates provides one mechanism for moving the plates in a controlled fashion, so that the plates are always aligned to each other while the plates are moved.

According to one embodiment of the system of hot plates, the system includes a linear movement means coupled to the upper plate and adapted to move the upper plate in two opposite directions, in a first direction towards the lower plate, and in a second direction away from the lower plate. This embodiment is helpful, as such movement mechanism keeps the plates parallel, which helps in provide equal heat and pressure at various point on the upper surface of the food item.

According to one embodiment of the system of hot plates, the system includes a coupling means which couples the upper plate to the linear mechanism. The coupling means allows free movement of the upper plate around the coupling means up to a predefined angle with respect to one or more axis passing through the coupling means. This embodiment provides for easy mechanism to counter uneven width of the food item, such that the slant of the upper plate can be maintained and significantly parallel to the upper surface of the food item,

According to another embodiment of the system of hot plates, wherein the coupling means is a ball joint which couples the upper plate to the linear mechanism in such a way, so as to allow free movement of the upper plate around the ball joint up to a predefined angle with respect to one or more axis passing through the ball joint. This embodiment provides for an effective and convenient mechanism to implement the features of the coupling means.

According to yet another embodiment of the system of hot plates, the system includes a suspension means coupled to the upper plate, which counters further motion of the upper plate towards the lower plate when the suspension means touches an upper surface or cooking surface of the food item.

According to one embodiment of the system of hot plates, the system includes a motor adapted to move the upper plate towards the lower plate up to a level, so as to maintain a predefined gap between the upper plate and lower plate. The suspension means is adapted to counter further motion of the upper plate towards the lower plate when the suspension means touches the upper surface or cooking surface of the lower plate, if a height of the food item is more than the predefined gap. This embodiment helps in a smooth mechanism to move the upper plate, and also to further remove any requirements to calibrate the motor, especially in scenarios when a particular dish may have different width as per skills of the chef who is assembling the food item before cooking

According to another embodiment of the system of hot plates, wherein when the plates are in a closed position to disallow access between the plates, the predefined gap remains between the plates. The system includes a gap controller adapted to vary the predefined gap between the plates. As different dishes has different height, this helps to change the predefined gap to be kept between the closed position, according to height of different kind of dishes being cooked

According to another embodiment of the system of hot plates, the system includes a temperature controller adapted to control temperature of each of the plates by varying heat provided by the heating medium, either individually or in combination. This embodiment helps in maintaining a desired temperature for each of the plates, so that appropriate heating can be provided for upper surface, as well as, lower surface of the food item.

According to yet another embodiment of the system of hot plates, the system includes an ejection mechanism which ejects the food item after the plates are disengaged. This embodiment helps in safely ejecting out the food item from the lower plate.

According to one embodiment of the system of hot plates, wherein the ejection mechanism is a rod placed in proximity to the lower plate, and adapted to move above the lower plate between two opposite edges of the lower plate. This embodiment provides a convenient mechanism to eject the food item from the lower plate without interfering with the plates while the cooking operation is going on.

According to another embodiment of the system of hot plates, wherein either the system comprising a blade attached to the rod, or the rod has a tapered end, such that the blade or the tapered end touches the lower plate when the rod moves above the lower plate. This embodiment provides additional utility for the rod, which can be used for spreading the cooking medium or batter onto the lower plate, and even can further be used to clean the surface of the lower plate.

According to yet another embodiment of the system of hot plates, wherein the rod maintains an ejector gap between the rod and the lower plate, wherein the ejector gap is less than the height of the food item. This embodiment keeps the rod away from the hot surface of the lower plate, as well as to remain to height which is appropriate to eject the foot item when the rod moves from one end of the lower plate to another end of the lower plate.

According to one embodiment of the system of hot plates, the system includes an ejector gap controller adapted to vary the ejector gap between the rod and the lower plate. This embodiment shall be helpful to change the ejector gap according to various food items, as each food item being cooked between the plates have different height, and accordingly the distance of the rod from the lower plate is required to be varied to appropriately eject the food item from the lower plate.

According to another embodiment of the system of hot plates, the system includes an input unit which receive a selection input related to a selection of a type of food item to be cooked. The gap controller receives and processes the selection input and vary the predefined gap between the plates based on the food item selected. The temperature controller receives and processes the selection input and controls temperature of each of the plates by varying heat provided by the heating medium, either individually or in combination. The dispensing controller receives and processes the selection input and controls dispensing of the cooking medium onto the food item. The ejector gap controller receives and processes the selection input, and varies the ejector gap. This embodiment provides for automating various functions of the system of hot plates, and substantially deskills the cooking process.

According to yet another embodiment of the system of hot plates, the system includes a sensor which is activated when the upper plate, or the lower plate, or both of them start moving to be in the closed position. The sensor, after being activated, generates a topological information of an environment between the plates. In furtherance, a processor receives and processes the topological information and generates an object geometrical information of one or more objects in the environment between the plates, fetches one or more food geometrical information of food items matching to the selection input, compares the object geometrical information and the food geometrical information, determines the object as unwanted object whose object geometrical information do not matches to the food geometrical information of the food item, and generates an alarm signal. The system includes an output unit which receives and renders the alarm signal.

According to one embodiment of the system of hot plates, wherein the temperature controller varies the temperature of the plates individually or in combination more than one time during a cooking cycle of the food item. For various cooking operations, the temperature change may be required multiple times during cooking. This embodiment is helpful to change the temperature of the plates appropriately as required for the cooking operation for a selected food item.

According to another embodiment of the system of hot plates, wherein the gap controller is adapted to vary the predefined gap between the plates more than one time during the cooking cycle of a food item. This embodiment is helpful to change the predefined gap between the plates appropriately multiple times as required for the cooking operation for a selected food item.

According to yet another embodiment of the system of hot, wherein the dispensing controller is adapted to dispense the cooking medium more than one time during the cooking cycle of a food item. This embodiment is helpful to allow dispensing of the cooking medium appropriately more than one times during the cooking operation as required for cooking the selected food item.

### BRIEF DESCRIPTION OF DRAWINGS

FIG. 1 illustrates a schematic diagram of a system of hot plates along with various automation elements, according to an exemplary embodiment of the invention.

FIG. 2 illustrates a first perspective view of the system of hot plates when the hot plates are in closed position.

FIG. 3 illustrates a second perspective view of the system of hot plates when the hot plates are in open position, and the ejection mechanism is in proximity to an edge of lower plate.

FIG. 4 illustrates the second perspective view of the system of hot plates when the hot plates are in open position, and the ejection mechanism is in proximity to another edge of lower plate opposite to the edge in FIG. 3.

The figures depict embodiments of the disclosure for purposes of illustration only. One skilled in the art will readily recognize from the following description that alternative embodiments illustrated herein may be employed without departing from the principles of the disclosure described herein.

### DETAILED DESCRIPTION

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

The invention focuses on providing a system of hot plates capable of pan frying a food item by applying heat and pressure from both sides of the food item. In furtherance the invention focuses on providing a system of hot plates, where various steps of cooking the food items are automated, so as to deskill the cooking process.

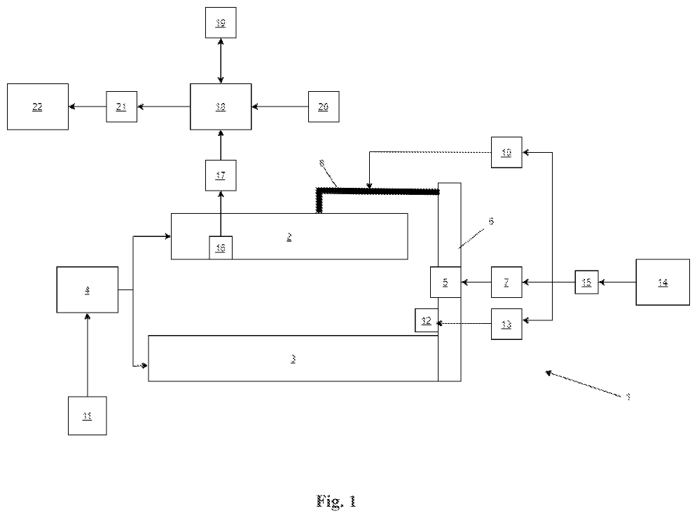

FIG. 1. illustrates schematic representation of a system 1 of hot plates along with all the automation components of it. The system 1 is provided with two plates 2, 3, one upper plate 2, and one lower plate 3. The upper plate 2 and the lower plate 3 are functionally coupled to press and heat a food item when the food item is placed between the plates 2, 3. To heat the plates 2, 3, a heating medium 4 is provided which can vary the heat to be provided on the plates 2, 3. The heating medium 4 can vary the heating provided to the plates 2, 3 individually, so that each of the plates can attain different temperatures, as per a requirement of cooking the food item. In furtherance, for pan frying, cooking medium, like oil, butter, ghee, etc., plays an important role. The system 1 is further provided with cooking medium dispensing means 5, so that the cooking medium can be applied automatically either on cooking surfaces of both the plates 2, 3, or onto the surfaces of the food item which are in contact with the cooking surfaces of the plates 2, 3. For appropriate cooking, firstly the cooking medium is dispensed onto the cooking surface of the lower plate 3, and thereafter, when the food item is placed onto the cooking surface of the lower plate, the cooking medium is dispensed on a upper surface of the food item which shall come in contact to the cooking surface of the upper plate while cooking.

It is pertinent to be noted that there can be more than one upper plate, or more than one lower plates, or both. This shall help to provide an efficient system for batch cooking for Mega kitchens which require high throughput. In one scenario, there can be one upper plate for multiple lower plates, which shall help easy handling of the upper plate which shall be required to move during the cooking operation. In another scenario, there can be only one lower plate for multiple upper plates, which shall help in each cleaning of the lower plate quickly.

The cooking medium dispensing means 5 is placed on a side wall 6 of the system 1. When the upper plate 2 moves up, the cooking medium dispensing means 5 is exposed to inside environment of the plates 2, 3, so it can appropriately dispense the cooking medium between the plates 2, 3. The cooking medium dispensing means 5 dispenses the cooking medium onto the lower plate 3, or onto the upper surface of the food item. In an alternate embodiment, where the plates 2, 3 are hinged, the cooking medium dispensing means 5 shall be provided on a wall opposite to the edges of the plates 2, 3 which are hinged. When the upper plate 3 opens up, the edge of the upper plate 3 lying in proximity to the cooking medium dispensing means 5 moves away from the corresponding edge of the lower plate 3, and thus exposes the cooking medium dispensing means 5 to the inside environment of the plates 2, 3.

To move the plates, a linear mechanism 8 is connected to the upper plate 2, and moves the upper plate 2 up and down linearly, away from the lower plate 3 or towards the lower plate 3 respectively. The movement of the upper plate 2 is helpful to give access to the environment between the plates 2, 3, and also dispensing of the cooking medium between the plates, and further appropriately press the plate to cook the food item. Another mechanism for moving the plates 2, 3, is to hinge the upper plate 2 to the lower plate 3, and to move the upper plate 2 around the hinge, to provide almost the similar functionality with respect to the current embodiment of the FIG. 1.

The upper plate 2 is further coupled to a suspension mechanism (not shown in the figure), which counters further motion of the upper plate 2 towards the lower plate 3 when the suspension means touches an upper surface of the lower plate 3. This embodiment takes care of crushing and deformation of the food item because of excessive pressure put on by the upper plate 2 onto the food item when the upper plate 2 moves to a close position to press and heat upper surface of the food item.

To move the upper plate 2, the linear mechanism 8 is provided with a motor (not shown in the figure). The motor moves the upper plate 2 towards the lower plate 3 up to a level, so as to maintain a predefined gap between the upper plate 2 and lower plate 3. Maintaining a predefined gap is significant, so as to allow proper cooking of the food item, however avoiding crushing of the food item. However, it is pertinent to be noted that each dish may have differential heights, as before putting the food item on the system 1, the food items are manually prepared and assembled by chefs, and there may be difference in cooking style of each chef, and accordingly different height may be provided by different chefs. Sometime, same chef may vary the height due to human error. In some scenario, there may be a special request from the client for additional ingredients or removing of some of the ingredients, which again can vary the height of the food item. This makes calibration of the motor difficult to maintain differential predefined gaps for the same dish. In such scenario, the suspension attached to the upper plate 2 comes handy. In such scenario, the suspension means counters further motion of the upper plate 2 towards the lower plate 3 when the suspension means touches the upper surface of the lower plate 3, if a height of the food item is more than the predefined gap.

To eject the food item after cooking, an ejection mechanism 12 is provided. This ejection mechanism 12 moves from one edge of the lower plate 3 to another edge, preferably opposite edge of the lower plate 3 to eject out the food item after cooking. The ejector mechanism 12 is a rod which is approximately equivalent to dimension of the edge of the lower plate 3 in whose proximity it is placed. This rod 12 moves between two opposite edges of the lower plate 3 to eject the food item. It is pertinent to be noted that this rod 12 maintains an ejector gap between the rod 12 and the lower plate 3. The ejector gap is less than the height of the food item. The ejector gap varies for different types of food items, as height of different food item differs.

In one embodiment, ejector mechanism 12 can be used for different functionalities like spreading of cooking medium onto the surface of the lower plate 3 or cleaning the lower surface. To provide for such functionalities, either the system 1 can have a blade attached to the rod 12, or the rod 12 can have a tapered end, such that the blade or the tapered end touches the lower plate 3 when the rod 12 moves above the lower plate 3.

To control various functionalities of different functional components of the system 1, different control mechanisms are provided. A dispensing controller 7 is provided which controls dispensing of the cooking medium onto the food item or onto the plates 2, 3. A gap controller 10 is provided which varies the predefined gap between the plates. A temperature controller 11 is provided which controls temperature of each of the plates 2, 3, either individually or in combination. An ejector gap controller 13 is provided which varies the ejector gap between the rod 12 and the lower plate 3.

Each food item has different requirements for heating temperature while cooking, has a different height, and requires different amount of cooking medium while cooking. Hence, for deskilling the cooking process across various food items, functioning of each of the controlling components are automated, i.e., the control mechanisms are triggered based on the food item selected to be cooked. For such automation, an input unit 14 is provided as part of the system 1, where a user can provide a selection input 15 to select a food item to be cooked. This selection input 15 is sent to each of these control mechanisms for further processing and triggering. The gap controller 10 processes the selection input 15 to identify height of the food item, and accordingly vary the predefined gap between the plates 2, 3, by calibrating motor of the linear mechanism 8 to maintain the predefined gap, while the plates 2, 3 are in the closed position to cook the food item by pressing the food item. The temperature controller 11 processes the selection input 15 to identify temperature requirement for the food item to be cooked, and time frame when it is required, and accordingly vary the heating of each of the plates separately or together for further controlling temperature of each of the plates 2, 3, either individually or in combination. The dispensing controller 7 processes the selection input 15 to identify quantity of cooking medium required and time frame when is required, and accordingly controls the cooking medium dispensing means 5 to control dispensing of the cooking medium onto the food item, or onto the plates 2,3. The ejector gap controller 13 processes the selection input 15 to identify height of the food item, and accordingly change the height of the rod 12 or the ejection mechanism 12 with respect to cooking surface of the lower plate to vary the ejector gap.

It is pertinent to be noted that the control mechanisms may be required to be apply control triggers at various time frames of cooking operation. Accordingly, the temperature controller 11 may vary the temperature of the plates 2, 3 individually or in combination more than one time during a cooking cycle of the food item. And, accordingly, the gap controller 10 may vary the predefined gap between the plates 2, 3 more than one time during the cooking cycle of a food item, especially in case of flatbreads like paratha which may change height during the cooking operation is going on. Similarly, the dispensing controller 7 may dispense the cooking medium more than one time during the cooking cycle of a food item.

In an alternate embodiment, all or some of the control mechanisms 7, 10, 11, 13 can be a mechanical means which can manually be operated by the user of the system 1, or it can be based on an electrical control mechanism, such as a rotor or a push button which provide electrical trigger to the control mechanisms 7, 10, 11, 13 to apply control functionality on various functional components 5, 8, 4, 12. The control mechanisms 7, 10, 11, 13 can also be based on human computer interface mechanism where the inputs are manually entered through the human computer interface to further provide trigger to control mechanisms 7, 10, 11, 13 to apply control functionality on various functional components.

To maintain safety, while carrying out the cooking operation, a mechanism is provided to identify foreign objects between the plates, and raise an alarm. For this functionality, the system 1 is provided with a sensor 16 which is activated when the upper plate 2 start moving to be in the closed position. The sensor 16, after being activated, generates a topological information 17 of an environment between the plates 2, 3. Further the system 1 is provided with a processor 18 which receives and processes the topological information 17 and generates an object geometrical information 19 of one or more objects in the environment between the plates 2, 3. The processor 18 further fetches one or more food geometrical information 20 of food items matching to the selection input 15 and compares the object geometrical information 19 and the food geometrical information 20 to determine the object as unwanted object whose object geometrical information 19 do not match to the food geometrical information 20 of the food item. On identification of such unwanted objects, the processor 18 generates an alarm signal 21 and sends the same to an output unit 22. The output unit 22 receives and render the alarm signal 21. The alarm signal may be audio or visual. It is pertinent to be noted that the safety feature is an additional feature, and may not be desired in all the systems 1 of the hot plates 2, 3.

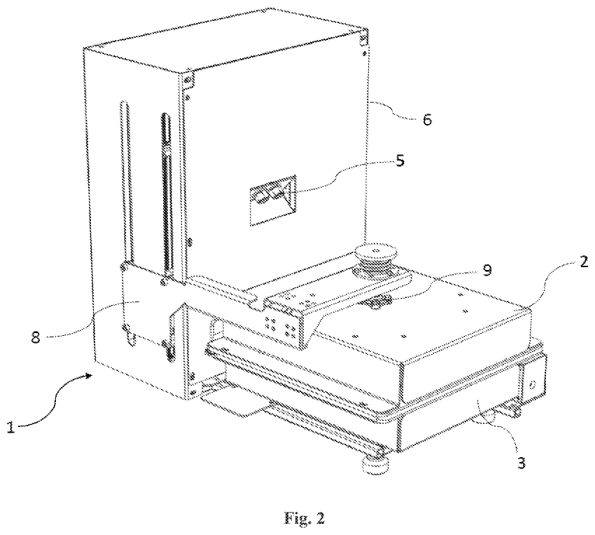

FIG. 2 illustrates a first perspective view of the system 1 of hot plates 2, 3 when the hot plates 2, 3 are in closed position. The system 1 is shown to have a cooking medium dispensing means 5 which is placed on a side wall 6, and oriented in such a way, so as to dispense cooking medium onto either the lower plate 2 or onto upper surface of the food item. The cooking medium dispensing means 5 are enabled to dispense the cooking medium only when the upper plate 2 have moved above the position of the cooking medium dispensing means 5. This properly dispose the inside environment between the plates 2, 3 to the cooking dispensing means 5. Even, orientation of the cooking dispensing means can be changed to dispense cooking medium onto the upper plate 2. The upper plate 2 is shown to be attached to a linear mechanism 8, which moves the upper plate 2 up and down, away from the lower plate 3 and towards the lower plate 3 respectively. The upper plate 2 is coupled to the linear mechanism 8 through a coupling means 9 which allows free movement of the upper plate 2 around the coupling means 9 up to a predefined angle with respect to one or more axis passing through the coupling means 9. In one embodiment, the coupling means is a ball joint allowing such free movement of the upper plate, so as to counter slant in upper surface of the food item.

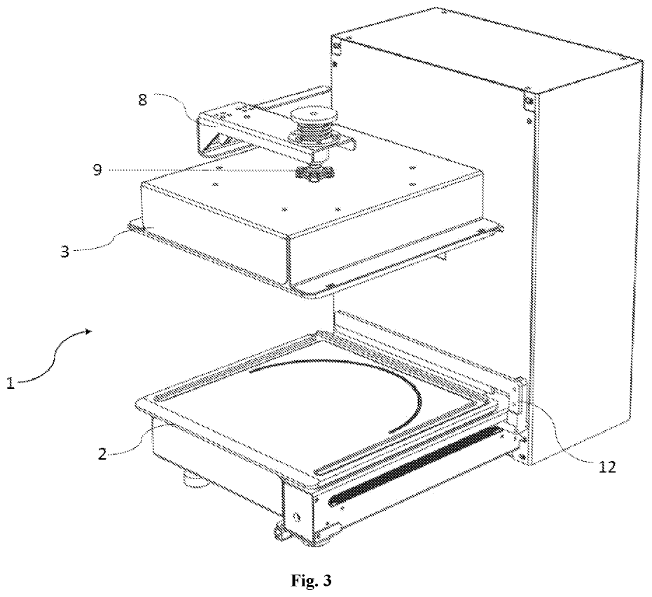

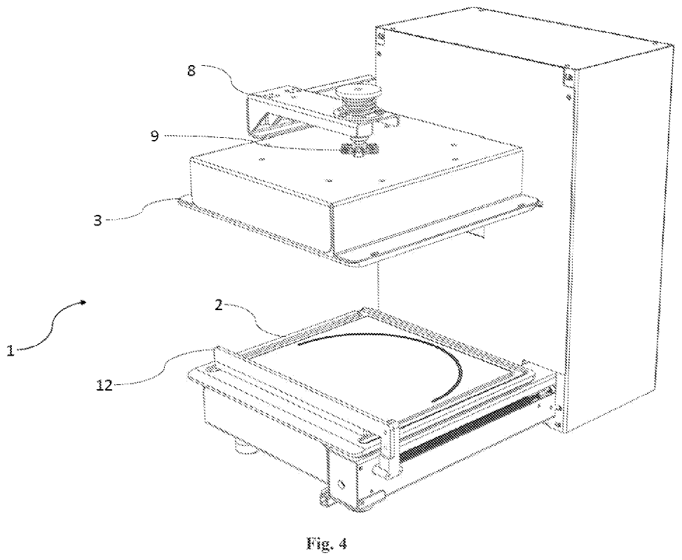

FIG. 3 illustrates a second perspective view of the system 1 of hot plates 2, 3 when the hot plates 2, 3 are in open position, and the ejection mechanism 12 is in proximity to an edge of lower plate. While, in FIG. 4, the ejection mechanism 12 is shown to be at the opposite edge with respect to the edge it was shown to be placed in FIG. 3. In this figure other components are provided which are similar to the illustrations of FIG. 2, and for the purpose of brevity, are not re-explained. Here, the ejection mechanism 12 is a rod which is shown to move between the edges to eject out the food items once they are cooked.

It is pertinent to be noted that the system 1 of the hot plates of the current inventions can be used to cook various types of flat breads, and food items, like sandwiches, which has a pan-frying requirement, and which are required to be pressed during cooking.

While specific language has been used to describe the invention, any limitations arising on account of the same are not intended. As would be apparent to a person skilled in the art, various working modifications may be made to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

### LIST OF REFERENCE NUMERALS

1 System of hot plates
2 Upper hot plate
3 Lower hot plate
4 Heating medium
5 Cooking medium dispensing means
6 Side wall
7 Dispensing controller
8 Linear movement means
9 Coupling means
10 Gap controller
11 Temperature controller
12 Ejection mechanism/rod
13 Ejector gap controller
14 Input unit
15 Selection input
16 Sensor
17 Topological information
18 Processor
19 Object geometrical information
20 Food geometrical information
21 Alarm signal
22 Output unit

1. A system (1) of hot plates (2, 3) comprising:
a heating medium (4) adapted to heat the hot plates (2, 3),
the more than one hot plates (2, 3), at least one of the plates is an upper plate (2) and at least one of another plate is a lower plate (3), wherein the upper plate (2) and the lower plate (3) are functionally coupled to press and heat a food item when the food item is placed between the plates (2, 3); and
a cooking medium dispensing means (5) adapted to dispense a predefined quantity of the cooking medium at least on an upper surface of the food item, or a lower surface of the food item.

2. The system (1) according to claim 1, wherein each of the plates (2, 3) are either categorized as the upper plate (2) or the lower plate (3), wherein the upper plates (2) and the lower plates (3) are functionally coupled together to press and heat a food item when the food item is placed between the plates (2, 3).

3. The system (1) according to claim 1, wherein the cooking medium dispensing means (5) is adapted to dispense the cooking medium onto the upper plate (2) or the lower plate (3) or combination thereof.

4. The system (1) according to claim 1, wherein the cooking medium dispensing means (5) is adapted to firstly dispense the cooking medium onto the lower plate (3) and thereafter onto the upper surface of the food item.

5. The system (1) according to claim 1, wherein the cooking medium dispensing means (5) is placed on a side wall (6) of the system (1) which gets exposed to the upper plate (2) and the lower plate (3), when at least one of a corresponding edge of the plates moves away from each other, and the cooking medium dispensing means (5) is adapted to dispense the cooking medium when it gets exposed to the upper plate (2) and the lower plate (3),
the system (1) optionally compromising:
a dispensing controller (7) adapted to control dispensing of the cooking medium onto the food item.

6. (canceled)

7. The system (1) according to claim 1, wherein the upper plate (2) and the lower plate (3) are physically coupled to each other around a hinge, so that the upper plate (2) and the lower plate (3) moves with respect to each other around the hinge for pressing and heating the food item, exposing the cooking medium to the upper plate (2) and the lower plate (3), or giving access to the food item.

8. The system (1) according to claim 1 comprising:
a linear movement means (8) coupled to the upper plate (2) and adapted to move the upper plate (2) in two opposite directions, in a first direction towards the lower plate (3), and in a second direction away from the lower plate (3),
the system optionally comprising:
coupling means (9) adapted to couple the upper plate (2) to the linear mechanism (8), the coupling means (9) is adapted to allow free movement of the upper plate (2) around the coupling means (9) up to a predefined angle with respect to one or more axis passing through the coupling means (9).

9. (canceled)

10. The system (1) according to claim 8, wherein the coupling means (9) is a ball joint which couples the upper plate (2) to the linear mechanism (8) in such a way, so as to allow free movement of the upper plate (1) around the ball joint up to a predefined angle with respect to one or more axis passing through the ball joint.

11. The system (1) accoridng to claim 1 compromising:
a suspension means coupled to the upper plate (2), and adapted to counter further motion of the upper plate (2) towards the lower plate (3) when the suspension means touches an upper surface of the lower plate (3).

12. The system (1) according to claim 11 comprising:
a motor adapted to move the upper plate (2) towards the lower plate (3) up to a level, so as to maintain a predefined gap between the upper plate (2) and lower plate (3),
wherein the suspension means is adapted to counter further motion of the upper plate (2) towards the lower plate (3) when the suspension means touches the upper surface of the lower plate (3), if a height of the food item is more than the predefined gap.

13. The system (1) according to claim 1, wherein when the plates (2, 3) are in a closed position to disallow access between the plates (2, 3), the predefined gap remains between the plates (2, 3), the system comprising:
a gap controller (10) adapted to vary the predefined gap between the plates.

14. The system (1) according to claim 1 compromising:
a temperature controller (11) adapted to control temperature of each of the plates (2, 3), either individually or in combination.

15. The system (1) according to claim 1 compromising:
an ejection mechanism (12) adapted to eject the food item after the plates (2, 3) are disengaged.

16. The system (1) acccording to claim 15, wherein the ejection mechanism (12) is a rod placed in proximity to the lower plate (3), and adapted to move above the lower plate (3) between two opposite edges of the lower plate (3).

17. The system (1) according to claim 16, wherein either the system (1) comprising a blade attached to the rod (12), or the rod (12) has a tapered end, such that the blade or the tapered end touches the lower plate (3) when the rod (12) moves above the lower plate (3).

18. The system (1) according to claim 16, wherein the rod maintains an ejector gap between the rod (12) and the lower plate (3), wherein the ejector gap is less than the height of the food item.

19. The system (1) according to claim 17 comprising:
an ejector gap controller (13) adapted to vary the ejector gap between the rod (12) and the lower plate (3).

20. A system (1) comprising:
a heating medium (4) adapted to heat the hot plates (2, 3),
the more than one hot plates (2, 3), at least one of the plates is an upper plate (2) and at least one of another plate is a lower plate (3), wherein the upper plate (2) and the lower plate (3) are functionally coupled to press and heat a food item when the food item is placed between the plates (2, 3);
a cooking medium dispensing means (5) adapted to dispense a predefined quantity of the cooking medium at least on an upper surface of the food item, or a lower surface food item;
an input unit (14) adapted to receive a selection input (15) related to a selection of a type of food item to be cooked;
the system (1) further compromising at least one of:
gap controller (10) adapted to receive and process the selection input (15) and adapted to vary a predefined gap between the plates (2, 3),
a temperature controller (11) adapted to receive and process the selection input (15) and adapted to control temperature of each of the plates (2, 3), either individually or in combination,
a dispensing controller (7) adapted to receive and process the selection input (15) and to control dispensing of the cooking medium onto the food item, and
a ejector gap controller (13) adapted to receive and process the selection input (15), and adapted to vary the ejector gap,
or a combination thereof.

21. The system (1) according to claim 20 comprising:
a sensor (16) adapted to be activated when the upper plate (2), or the lower plate (3), or both of them start moving to be in the closed position, the sensor (16), after being activated, adapted to generate a topological information (17) of an environment between the plates (2, 3),
a processor (18) adapted to receive and process the topological information (17) to generate object geometrical information (19) of one or more objects in the environment between the plates (2, 3), to fetch one or more food geometrical information (20) of food items matching to the selection input (15), to compare the object geometrical information (19) and the food geometrical information (20), to determine the object as unwanted object whose object geometrical information (19) do not match to the food geometrical information (20) of the food item, and to generate an alarm signal (21),
an output unit (22) adapted to receive and render the alarm signal (21).

22. The system (1) according to claim 20, wherein;
the temperature controller (11) is adapted to vary the temperature of the plates (2, 3) individually or in combination more than one time during a cooking cycle of the food item, or
the gap controller (10) is adapted to vary the predefined gap between the plates (2, 3) more than one time during the cooking cycle of a food item, or
the dispensing controller (7) is adapted to dispense the cooking medium more than one time during the cooking cycle of a food item, or
combination thereof.

23. (canceled)

24. (canceled)
